(19) United States
(12) Patent Application Publication
(10) Pub. No.: US 2010/0021351 A1
(43) Pub. Date: Jan. 28, 2010

(54) COLLECTION OF BIOLOGICAL SAMPLES

(75) Inventor: Vera Holländer, Hilden (DE)

Correspondence Address: Baker Donelson Bearman, Caldwell & Berkowitz, PC, 555 Eleventh Street, NW, Sixth Floor, Washington, DC, 20004, US

(73) Assignee: QIAGEN GMBH, Hilden (DE)

(21) Appl. No.: 12/518,429

(22) PCT Filed: Dec. 12, 2007
(86) PCT No.: PCT/IB2007/004162

§ 371 Date: Jul. 23, 2009

(30) Foreign Application Priority Data
Dec. 12, 2006 (DE) 10 2006 058 786.3

(51) Int. Cl. B01L 3/00

(52) U.S. Cl. 422/102

(57) ABSTRACT

The present invention relates to a container for receiving a liquid biological sample, with a volume for receiving the liquid biological sample, and with a filling and/or removal opening for filling the volume with the sample and for removing the sample from the volume. The invention is distinguished in that a constriction or partition forming an aperture is arranged in the volume in order to partition off a predefined measured volume from the volume.

The present invention relates in general to the collection of biological samples and in particular to a sample collecting container, for example a container for removed body fluids, such as saliva, sputum, urine, sperm, blood, etc., and also to an associated use. Liquid biological samples frequently have to be present in a defined volume in order, for example, to carry out analyses therewith or in order to stabilize biomolecules located therein or to define the morphology of the cells possibly contained therein.

In the known operation, the liquid sample is first of all collected in a container, for example a urine cup, and the required volume is subsequently measured out therefrom outside the container, for example by pipetting, and removed in order then to add, for example, reagents for a possible detection reaction to the measured-out volume. However, this firstly requires a plurality of time-intensive, labor-intensive and possibly health-endangering steps during the handling of the sample. In addition, the opening of the container and contact with a plurality of vessels during the measuring out of the volume may result in the sample being contaminated. Said procedure is also problematical in particular if the sample is infectious, and the health of the person handling the sample is therefore put at risk by the decanting of the sample. In addition to the awkward decanting and measuring steps, further processing may be delayed such that stabilization which may be required may not take place to an adequate extent and, for example, transcriptome, proteome or metabolites may be changed during this time (for example by degradation, induction or modification).

Furthermore, it is known to remove blood in predefined quantities with the aid of vacuum tubes (Vacutainer® from Becton Dickingson GmbH) and, if appropriate, to stabilize it immediately upon removal by a stabilizing reagent (PAXgene RNA blood tube) contained in the vacuum tube. Said vacuum technique, in which a vacuum is used to suck up the appropriate quantity of blood until pressure is equalized, can only be used invasively, since the removal system has to be airtight and therefore, due to the unacceptable effect on the patient, is entirely unsuitable for removing saliva and urine. Furthermore, fixed, sucking matrices are known (for example Quantisal-Saliva collection device from Immunalysis Corp.), in which a liquid-sucking matrix is fastened on a stem, the matrix is placed into the mouth and saliva is sucked up. When the required volume of saliva is reached, a color reaction can be seen on the stem. The matrix is then inserted into the associated container which contains a stabilization solution. It has been shown in a number of tests that the method disadvantageously does not appear to be compatible with nucleic acid isolation, and the test person-s mouth dries out unpleasantly during the sample-taking. If the method is used for different samples, an operation to collect the sample in a further container is also required.

Against the background of the above-described disadvantages of the devices of the prior art, it is therefore the object of the present invention to provide a device which accelerates the taking of a sample, in particular a body fluid, improves the handling, inter alia with respect to hygiene and sterility, can be produced at a reasonable price and is suitable for disposable use. This object is achieved by the features of the independent claim. An advantageous use is the subject matter of the further independent claim. The dependent claims relate in each case to advantageous configurations.

The invention relates to a container for receiving a liquid biological sample, with a volume for receiving the liquid biological sample, and with a filling and/or removal opening for filling the volume with the sample and for removing the sample from the volume. The invention is distinguished in that a constriction forming an aperture or a partition with an aperture is arranged in the volume in order to partition off a predefined measured volume from the volume. The biological sample is in general any substantially flowable biological sample, for example a human or animal body fluid, such as serum, plasma, saliva or sputum, a substantially liquid exudation product, such as, for example, urine, sputum, rinses and washes (for example mouth rinses), solutions of biological samples and a liquid environmental sample, for example a water sample, or a rinse, wash, suspension etc. “Substantially liquid” is to be understood as meaning that the sample can also have non-dissolved solid contents. Furthermore, liquid is to be understood as meaning that the flowability of the sample is such that the measured volume provided according to the invention can be used as a partition, and therefore even viscous sample liquids are possible. However, the invention is not restricted to biological samples, but rather can be used, with the advantages provided according to the invention, for any type of liquid which is to be collected and investigated. The constricting or partitioning of the volume in the container into a further chamber with a predefined measured volume makes it possible, after the excess sample liquid is poured off, for the sample liquid to be retained in the quantity predetermined in the predefined measured volume by means of the partition or constriction. The comparatively small aperture and the arrangement thereof, for example on that side of the partition or constriction which is as far away as possible from the removal opening, substantially prevents sample liquid in the predefined measured volume from being lost when decanting the excess quantity of sample liquid, i.e. the quantity going beyond the predefined volume, via the removal opening. By means of this configuration, removal of the sample liquid and measuring out of a sample liquid quantity corresponding to the defined measured volume are rapidly achieved with just one container. By reducing the number of actions during the taking of the sample and reducing the number of required vessels, the risk of infection in the case of infectious sample liquids is drastically reduced. The operations also turn out to be simple and can therefore be carried out by individuals who are not medically trained or by the test person himself.

The container is composed, for example, of plastic, in particular polypropylene, PE, such as LDPE or PET, PVC and PVF, preferably of biologically degradable plastic, and is produced, for example, in a step involving the injection molding of plastic, injection blow molding of plastic or extrusion blow molding of plastic. The container is in the form, for example, of an Eppendorf vessel for small quantities of the sample liquid, the form of a Falcon tube for quantities in the region of 50 ml and, in the case of larger volumes, is in the form of a known urine cup. Furthermore, the container can be designed in such a manner that it is suitable for further processing in commercially available centrifuges.

The container is, for example, of transparent or translucent design in order to be able more easily to check the degree of filling and the decanting of the excess sample liquid.

In one configuration, an opening is provided in the container as a filling opening and is the removal opening. Furthermore, the filling opening is matched to the conditions during the sample-taking and is correspondingly configured. For example, a mouthpiece is provided if the sample involves sputum or spittle. The removal opening is likewise matched to the corresponding conditions for further processing. For example, it involves a simple beak-shaped spout or a Luer connection, etc.

In a further advantageous configuration, in the container according to the invention the aperture is arranged in such a manner that it is visible via the filling and/or removal opening. As a result, the level of the quantity of sample liquid located in the volume predefined by the partition or constriction can easily be checked. If said predefined volume is completely filled, the surface tension in the aperture of the partition or the constriction and the associated light refraction in the lenticular distortion of the surface ensure that said state can easily be seen via the filling and/or removal opening. This ensures a very rapid and effective checking of the level, since, in addition, the presence of the partition or of the constriction means that the actual filling height is only to be estimated in the region of the aperture rather than over the entire diameter of the volume of the container, and the visual change in the aperture when the filling level sought is reached is highly self-evident.

In order to make it easier to see the filling height sought, that region of the partition or constriction which surrounds the aperture can be marked in color or provided with a dye which indicates the sought filling level upon contact with the sample liquid by changing color.

The aperture in the partition or constriction has, for example, a diameter enabling a commercially available pipette to be introduced into the defined volume in order to take further samples therefrom.

In an advantageous configuration, the container and the constriction or partition are designed as a single piece. As a result, the device according to the invention can be produced at a comparatively reasonable price.

In an advantageous configuration, the constriction or partition is of a funnel-shaped design. This prevents the sample liquid from coming to rest on the partition or constriction and instead it runs through the opening into the predefined volume. In a further configuration, the surface of that region of the constriction or partition which is around the aperture is provided with an adhesion-reducing coating, which, for example, improves the entry of viscous sample liquids, such as saliva and sputum, into the predefined volume.

In a further advantageous configuration, the partition is designed in a manner such that it can be inserted into the volume of the container. This advantageously enables the constriction or partition, which may obstruct further processing of the sample, to be removed. Access to the sample liquid is thus no longer restricted by the aperture.

In a further configuration, the constriction or partition is realized by means of a funnel which can be inserted into the container. Said funnel is used, for example, only for the taking of the sample, the placing thereof into the volume and the measuring out of the predefined volume. The funnel can advantageously then be removed, thus making access to the sample liquid easier.

In a further advantageous configuration, a cover for closing the filling and/or removal opening is provided in order to prevent the sample from being contaminated during storage and transportation of the sample.

According to a further advantageous configuration, a partitioned volume is provided in the measured volume, for example for a reagent which is separated from the measured volume by a further breakable partition, for example a septum. Breakable within the context of the invention is to be understood as meaning that, after the filling with the sample liquid, the partition is pierced and partially or completely destroyed in order to thoroughly mix the solid or liquid substances in the partitioned volume with the sample liquid. It is particularly advantageous to separate the reagent and sample liquid where contact between the reagent and sample liquid during the collecting operation is not desirable and/or where precise metering of the reagent is important.

For example, the further breakable partition is destroyed by ultrasound or by thermal action or reacts, causing it to disintegrate, with the sample liquid, etc. For example, a reagent for stabilizing biomolecules or for defining morphological structures or for the direct analysis of the sample liquid (for example analytical reagents for color reactions in order to detect certain molecules) or for preventing foaming is located in the partitioned volume.

This permits rapid processing of the sample. The substance, i.e. the reagent, in the partitioned volume does not have to be inserted in a complicated manner. Contact with the sample is thus restricted to a minimum. The thorough mixing of the sample liquid and reagent can be promoted by shaking or “vortexing”.

In a further advantageous configuration, a breaking element which can be actuated from the outside of the container and causes destruction of the partition is provided. For example, the breaking element is a pointed ram which can use its point to make a cut and therefore an aperture in the breakable partition. As a result, destructibility of the breakable partition can be realized comparatively cost-effectively. The only important factor of the destruction is that contact occurs between the substance in the partitioned volume and the sample liquid, and said destruction can therefore be broadly interpreted and comprises, for example, perforating, cutting in, etc.

In a further advantageous configuration, the breaking element is attached to the cover. As a result, the container can be produced at reasonable price and the breaking element is readily accessible.

According to a further advantageous configuration, the breaking element is attached to the cover in such a manner that, in the closed position of the cover, for example with the cover entirely plugged or screwed onto the filling and/or removal opening, destruction of the further breakable partition is caused. This makes the handling of the sample and further processing of the substance located in the partitioned volume particularly safe.

According to a further advantageous configuration, the container has a closing element for closing the aperture in the partition for the measured volume. This can make it easier to remove or decant the excess quantity of sample volume i.e. the quantity which goes beyond the measured volume, and to increase the accuracy of the measuring-out operation thus taking place, since sample liquid cannot penetrate out of the measured volume during the removal or decanting. The closing element is advantageously attached to the cover in order to reduce the production costs.

In a further advantageous configuration, the cover is attached adjustably to the container and is movable at least from a position not sealing the filling and/or removal opening into a closing position which seals the filling and/or removal opening, wherein, in the non-sealing position, the aperture is closed by the closing element.

For example, the cover and container are provided in the region of the filling and/or removal opening with an interacting screw thread in order to be able to screw on and unscrew the cover or rotate it between the two positions. The handling of the sample liquid in the container proves particularly simple as a result, since correction of a sample quantity can be undertaken retrospectively in a simple manner by, in the non-sealing position, excess sample liquid being able to be removed, i.e. decanted, from the container without sample liquid coming out of the measured volume on account of the closure of the aperture in the partition. This firstly increases the accuracy of the measurement by avoiding losses in the measured volume. Secondly, the measuring out is thus made easier in the case of cloudy sample liquids, such as urine, in which visual measuring out succeeds only with difficulty.

Furthermore, in a further advantageous refinement, in the sealing position of the cover, the further breakable partition is destroyed by the breaking element.

In a further configuration, a human or animal body fluid, preferably saliva, sputum, urine or sperm, is located in the container.

In a further advantageous configuration, the container contains a reagent. For example, a reagent for stabilizing biomolecules or for defining morphological structures or for the direct analysis of the sample liquid (for example analytical reagents for color reactions in order to detect certain molecules) or for preventing foaming is located in the partitioned volume. As an alternative, if a defined metering of the reagent is not important, the reagent may also be located in the measured volume without being partitioned off. For example, it is applied to the inner walls of the container or of the measured volume in a “spray-dry” process.

The invention furthermore relates to the use of the container in one of the previously described embodiments for collecting body fluid, preferably saliva, sputum, urine and sperm.

With regard to the figures:

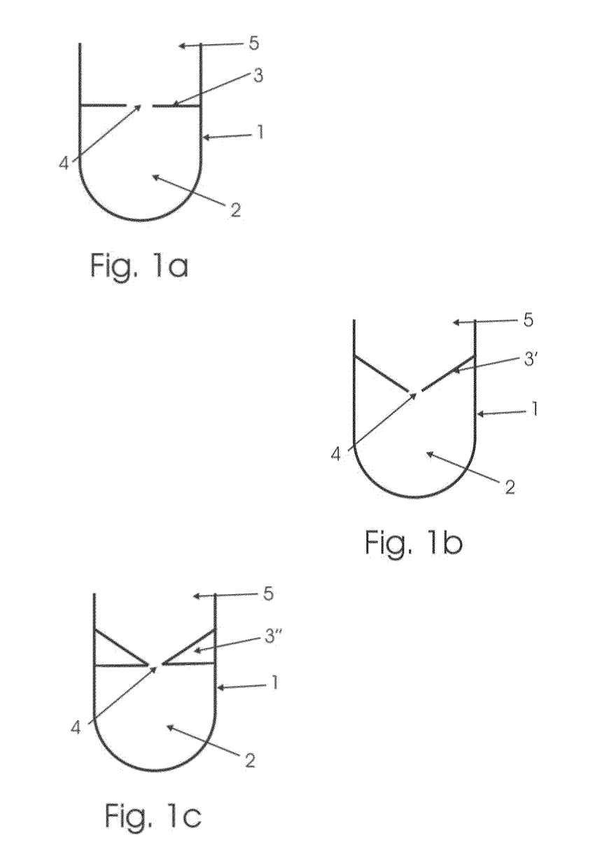

FIG. 1a shows a first embodiment of the container 1 according to the invention in section. The container 1 shown is suitable for receiving a sample liquid via the filling and removal opening 5, for example a human or animal body fluid. The volume of the container 1 has a measured volume 2 which is partitioned off by the partition 3, with the sample liquid entering the measured volume 2 via the aperture 4 in the partition 3 during the filling, i.e. taking of the body fluid. The partition 3 and the comparatively small aperture 4 serve to be able easily to pour away the excess sample liquid via the filling and removal opening without substantial quantities of the measured volume 2 being lost. In addition, the distortion, which arises when the filled measured volume is reached, of the sample liquid because of the surface tension in the region of the aperture 4 makes it possible to easily check the filling level by looking into the container 1 via the filling and removal opening 5. FIG. 1b shows a further embodiment in which the sample liquid can more easily enter the measured volume 2, because of the effect of gravity, through the funnel-shaped configuration of the partition 3′. FIG. 1c shows the case in which the measured volume 2 is designed in the form of a constriction 3″ of the container wall surrounding the volume.

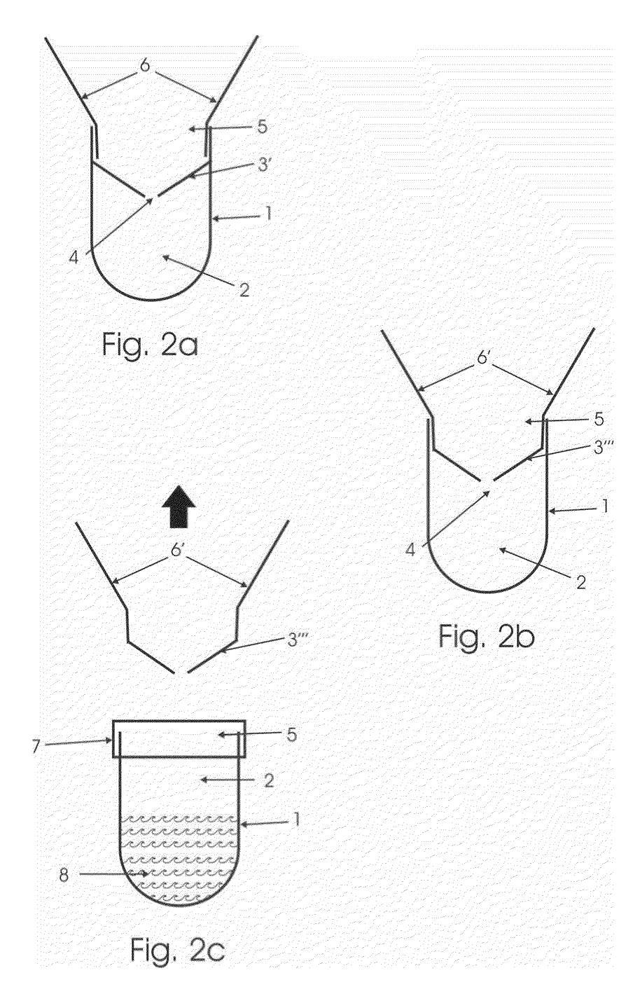

FIG. 2a shows the embodiment of the container 1 from FIG. 1b, in which the filling and removal opening 5 is “expanded” by an inserted funnel 6 in order to make filling easier.

FIG. 2b shows a further embodiment in which the partition 3″′ is designed as a funnel-shaped insert 6′. This not only facilitates the filling of the container via the filling and removal opening 5 but also makes it possible to remove the funnel-shaped insert 6′ in order to facilitate further processing or the removal of the sample liquid 8 from the measured volume 2, as shown in FIG. 2c. The filling and removal opening 5 of the container 1 is then closed by a cover 7 in order to avoid contamination of the sample liquid 8.

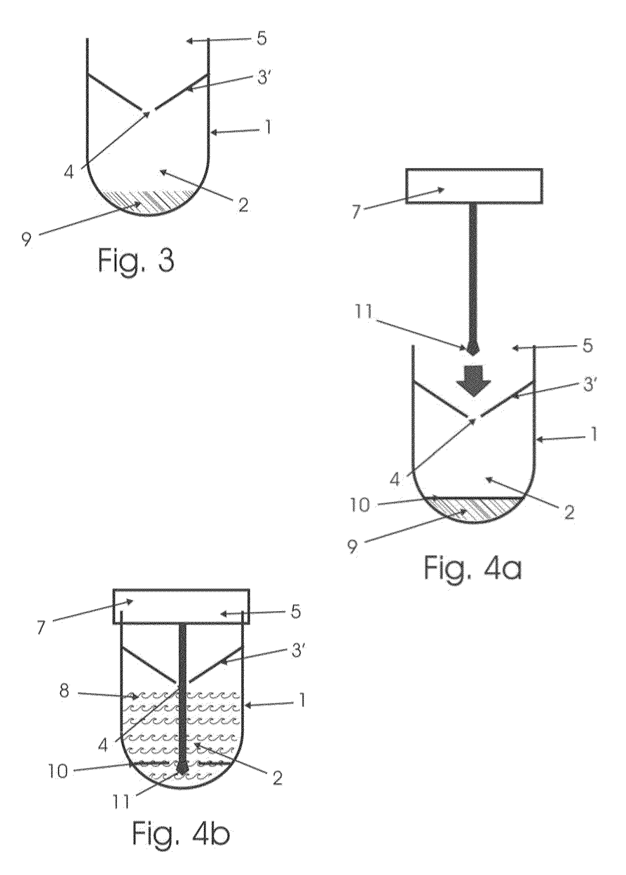

FIG. 3 shows the embodiment shown in FIG. 1b, in which a reagent is inserted into a partitioned volume 9 in the container 1. FIG. 4a shows a further embodiment of the container 1 according to the invention in which the reagent is located in a partitioned volume 9 partitioned off from the measured volume. The reagent is partitioned off from the measured volume 2, in which the sample liquid will be located after being taken, by the further breakable partition 10. It is particularly advantageous to separate the reagent and sample liquid where contact between the reagent and sample liquid during the collecting operation is not desired and/or precise metering of the reagent is important. The further breakable partition 10 is pierced by the breaking element 11 which is attached to the cover 7 and, for example, when the cover 7 is placed or screwed on after the sample liquid 8 has been collected, acts via the aperture 4 on the breakable partition 10 in order to pierce the latter, as shown in FIG. 4b. Only then are the reagent and sample liquid thoroughly mixed. In order to assist the mixing, the breaking element can be designed in the form of a stirrer in order to assist the thorough mixing, for example without using hands or by means of the rotational movement when screwing on the cover 7.

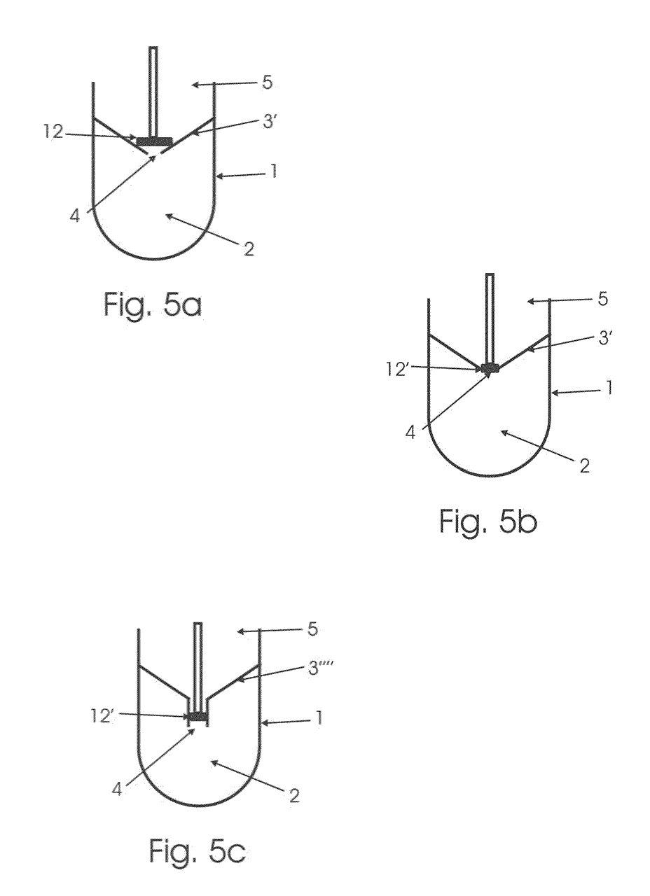

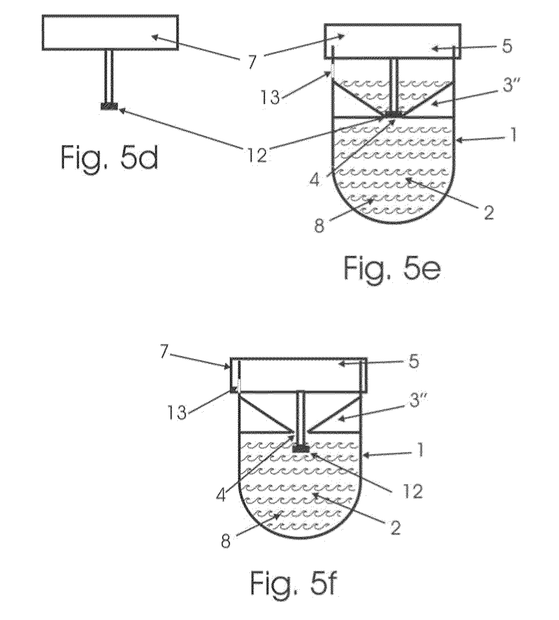

In the case of sample liquids in which visual checking of the filling height is difficult during the sample taking and collecting (for example as in the case of urine), a retrospective correction of the volume is advantageous. The sample liquid is placed into the volume of the container 1, with the filling height of the measured volume being exceeded and the excess liquid being removed again. FIGS. 5a-5c show embodiments in which a closing element 12, 12′, which can be actuated from the outside of the container 1, in the form of a ram is capable of closing the aperture in the partition 3′ and therefore the measured volume. Excess sample liquid can then be poured away without sample liquid escaping from the measured volume 2. In FIG. 5a, this is achieved by a closing element 12, for example made of soft plastic or rubber, resting on the aperture in a plate-like manner. In FIG. 5b, this is achieved by a closing element 12′ which can be inserted into the aperture 4, and in FIG. 5c by the insertion of the closing element 12′ into a tubular extension of the funnel-shaped partition 3″″. In this case, the ram with the closing element 12, 12′ can be attached individually or preferably to the cover 7, as shown in FIG. 5d. The closing element 12 and cover 7 are arranged in such a manner that the cover 7 is movable at least from a position not sealing the filling opening 5 and the removal opening 13, as shown in FIG. 5e, into a position sealing the filling and/or removal opening 5, as shown in FIG. 5f, wherein, in the non-sealing position, the aperture 4 is closed by the closing element 12. As a result, the handling of the sample liquid 8 in the container 1 proves particularly simple, since correction of a sample quantity can be undertaken retrospectively in a simple manner by it being possible, in the non-sealing position, for excess sample liquid 8 to be removed, i.e. poured away, from the container 1 via the removal opening 13 without sample liquid 8 coming out of the measured volume 2 because of the closure 12 of the aperture 4 in the partition 3″. This firstly increases the measuring accuracy by avoiding losses from the measured volume. Secondly, the measuring out is thus made easier in the case of cloudy sample liquids, such as urine, in which the visual measuring out succeeds only with difficulty. In the sealing position (shown in FIG. 5f) of the cover 7, the latter ensures that the removal opening 13 and the filling opening 5 are sealed. The adjustability of the cover 7 can be achieved, for example, by means of latching when the cover 7 is pressed on, or by means of rotation of the cover 7 which is connected to the container 1 by means of a screw thread.

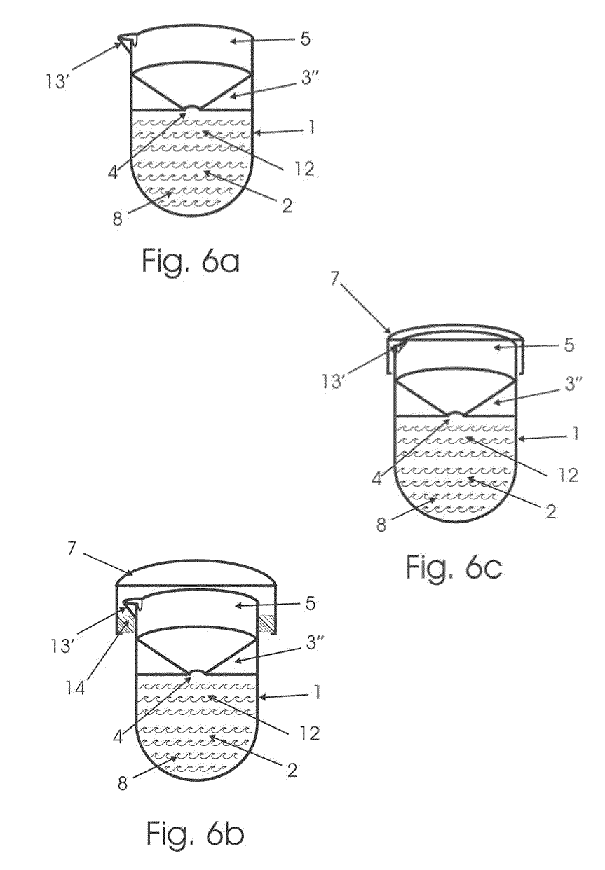

FIG. 6a shows the simplest form of a removal opening 13′ in the form of a beak-shaped spout. FIGS. 6b and 6c show different embodiments in which the removal opening 13′ is sealed in a different manner by the cover. In FIG. 6b, the sealing is achieved by a sealing element 14 arranged in the cover 7. In FIG. 6c, the sealing is achieved by squeezing in the spout 13′ which is composed, for example, of deformable material.

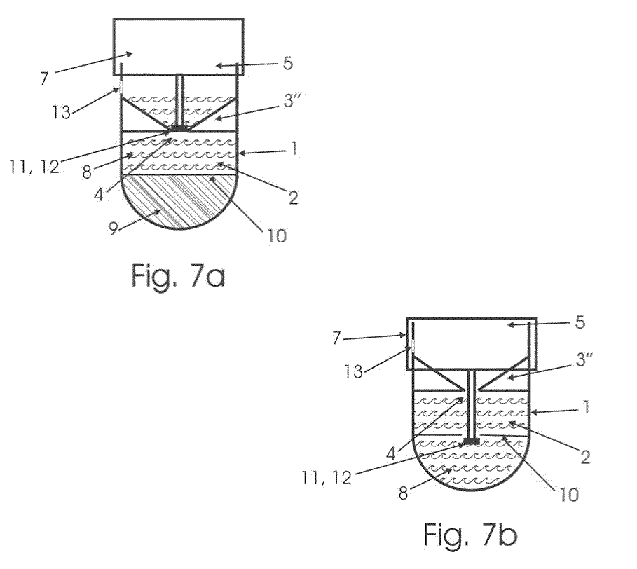

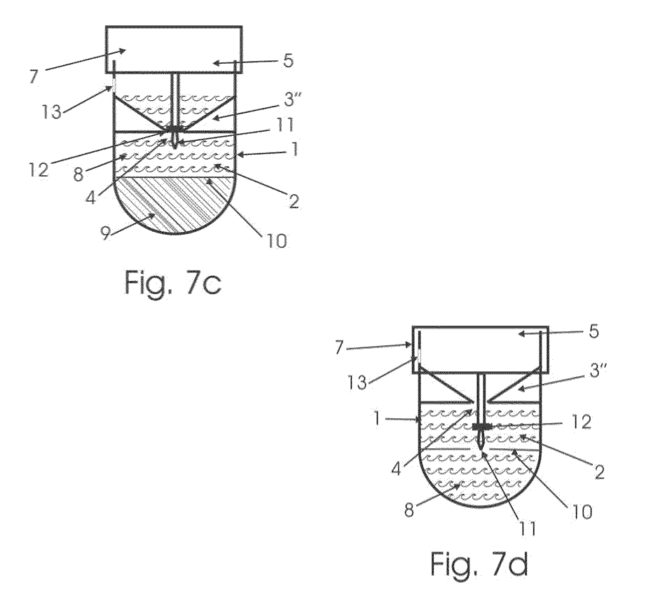

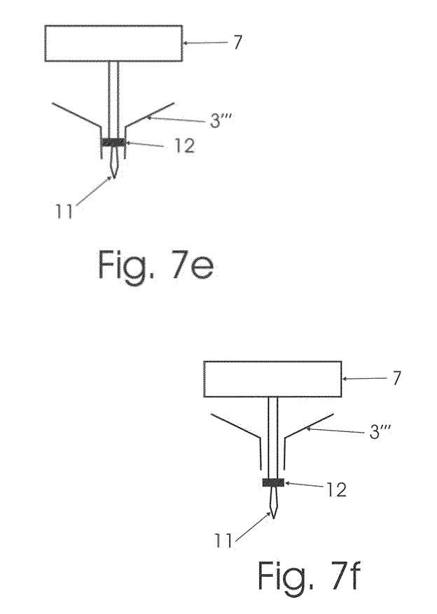

Reference is made below to FIGS. 7a-7d; the container 1, which has subsequent volume correction, contains a reagent which has been placed in advance into the partitioned volume 9, inter alia because a defined ratio of sample liquid and reagent is important. After the filling with the sample liquid 8 there is too much sample liquid 8 in the container, i.e. a quantity going beyond the quantity of the measured volume 2, see FIG. 7a. In the shown, non-sealing position of the cover 7, the excess sample liquid 8 can be removed via the removal opening 13 without sample liquid coming out of the measured volume 2 because of the sealing effect of the closing element 12 in the aperture 4. After the measuring out, i.e. the volume correction, has taken place in this manner, the cover 7 is placed or screwed completely into the sealing position, as shown in FIG. 7b. The container 1 is closed. At the same time, the closing element 12, which penetrates more deeply into the container 1 and acts here as a breaking element 11, causes destruction of the further breakable partition 10 of the partitioned volume in which the reagent is located. Well metered thorough mixing of the reagent and sample liquid occurs.

The container 1 in the embodiments shown in FIGS. 7c and 7d differs from those shown in FIGS. 7a and 7b only in that a lance-shaped breaking element 11 is arranged on the closing element 12 in order to cause destruction of the further breakable partition. This is shown in detail in FIGS. 7e and 7f. In the non-sealing position of the cover of FIG. 7e, i.e. after the initial placing on of the cover 7 following filling with the sample liquid, the closing element 12 closes the aperture 4 in the partition 3″′ with respect to the measured volume. In the sealing position of FIG. 7f, the breaking element 11 advances further together with the closing element 12. The closing element 12 opens up the aperture 4, which is insignificant since the container 1 is sealed in this state by means of the cover 7. The breaking element 11 now comes into contact with the partition and ensures the destruction thereof.

1. A container for receiving a substantially liquid biological sample, with a volume for receiving the substantially liquid biological sample, and with a filling and/or removal opening for filling the volume with the sample and for removing the sample from the volume, wherein a constriction or partition forming an aperture is arranged in the volume in order to partition off a predefined measured volume from the volume.

2. The container of claim 1, wherein the aperture is arranged in such a manner that it is visible via the filling and/or removal opening.

3. The container of claim 1, wherein the container and the constriction or partition are designed as a single piece.

4. The container of claim 1, wherein the constriction or partition is of funnel-shaped design.

5. The container of claim 1, wherein the partition is designed in a manner such that it can be inserted into the volume of the container.

6. The container of claim 1, further comprising a cover for closing the filling and/or removal opening.

7. The container of claim 1, with a partitioned volume located in the measured volume, and is separated from the measured volume by a further breakable partition.

8. The container of claim 7, further comprising a breaking element which can be actuated from the outside of the container and which causes destruction of the further breakable partition.

9. The container of claim 8, wherein the breaking element is attached to the cover.

10. The container of claim 9, wherein the breaking element is attached to the cover in such a manner that, in a closed position of the cover, destruction of the further breakable partition is caused.

11. The container of claim 1, further comprising a closing element for closing the aperture.

12. The container of claim 11, wherein the closing element is attached to the cover.

13. The container of claim 12, wherein the cover is attached adjustably to the container and is movable at least from a position not sealing the filling and/or removal opening into a position sealing the filling and/or removal opening, wherein, in the non-sealing position, the aperture is closed by the closing element.

14. The container of claim 13, wherein, in a sealing position, the further breakable partition (10) is destroyed by the breaking element.

15. The container of claim 1, wherein a biological sample is located therein.

16. The container of claim 15, wherein the biological sample comprises a, substantially liquid sample having a solid component.

17. The container of claim 1, wherein further a reagent is located therein.

18. A method for the removal of or for collection of a liquid biological sample comprising using a container of claim 1.
